(19) United States
(12) Patent Application Publication
(10) Pub. No.: US 2014/0028005 A1
(43) Pub. Date: Jan. 30, 2014

(54) Airbag Inflator and Method for Forming Airbag Inflator

(71) Applicant: Ticona LLC, Florence, KY (US)

(72) Inventors: David C. Almond, Shropshiric (GB); Jill M. Higgins, Bloomfield Twp, MI (US); Cathy Daggett, Riley, MI (US); Michael Ruby, Cincinnati, OH (US)

(73) Assignee: Ticona LLC, Florence, KY (US)

(21) Appl. No.: 13/947,176

(22) Filed: Jul. 22, 2013

Related U.S. Application Data
(60) Provisional application No. 61/674,891, filed on Jul. 24, 2012.

(51) Int. Cl. B60R 21/26

(52) U.S. Cl. CPC B60R 21/26
USPC 280/741

(57) ABSTRACT

Airbag inflators and methods for forming airbag inflators are disclosed. An airbag inflator includes a hollow body comprising a wall, the wall having an inner surface defining an interior and an outer surface. The airbag inflator further includes a reinforcement layer surrounding and bonded to the hollow body. The reinforcement layer has an inner surface and an outer surface, the inner surface of the reinforcement layer in contact with the outer surface of the wall. The reinforcement layer is formed from a fiber reinforced thermoplastic material comprising a plurality of fibers dispersed in a thermoplastic resin.

### CROSS REFERENCE TO RELATE APPLICATION

The present application claims filing benefit of U.S. Provisional Patent Application Ser. No. 61/674,891 having a filing date of Jul. 24, 2012, which is incorporated by reference herein in its entirety.

### BACKGROUND OF THE INVENTION

Reducing mass while maintaining structural integrity is an important consideration in many industries. For example, the automotive industry is presently working to meet pending fuel economy and emission requirements. One factor in accomplishing these goals is the mass and structural integrity of various automotive components. The addition of, for example, safety equipment, convenience items, and onboard electronics has increased the weight of the average automobile. Alternative propulsion systems which seek to reduce emissions, such as hybrid-electric systems, fuel cells, and electric-drive systems, have further increased this weight. This leads to losses in fuel economy due to efforts to reduce emissions.

In an effort to reduce mass, many industries, including the automotive industry, are investigating the use of composite materials. For example, in the automobile industry, one component of particular concern is the airbag inflator. The use of airbags in automobiles has significantly increased in recent years. For example, from the year 2000 to the year 2005, worldwide use of airbags increased by 1035% for curtain airbags, 228% for side airbags, and 14% for front airbags. Further, current trends show that the number of airbags per individual automobile is increasing. As such, improvements in airbag technology are becoming of increased concern.

In particular, efforts are being made to reduce the weight of airbag inflators while maintaining or increasing the strength and pressure ratings of the airbag inflators. For example, many airbag inflators utilize canisters made from steel or other suitable metals. However, these metal materials are typically relatively heavy. Recently, the use of thermoset materials to form airbag inflators has been investigated. However, the use of thermosets in these applications requires a relative messy and time-consuming process.

Accordingly, improved airbag inflators are desired in the art. In particular, airbag inflators that are relatively lightweight while maintaining structural integrity would be advantageous.

### SUMMARY OF THE INVENTION

In accordance with one embodiment of the present disclosure, an airbag inflator is disclosed. The airbag inflator includes a hollow body comprising a wall, the wall having an inner surface defining an interior and an outer surface. The airbag inflator further includes a reinforcement layer surrounding and bonded to the hollow body. The reinforcement layer has an inner surface and an outer surface, the inner surface of the reinforcement layer in contact with the outer surface of the wall. The reinforcement layer is formed from a fiber reinforced thermoplastic material comprising a plurality of fibers dispersed in a thermoplastic resin.

In accordance with another embodiment of the present disclosure, a method for forming an airbag inflator is disclosed. The method includes surrounding a hollow body with a reinforcement layer such that an inner surface of the reinforcement layer is in contact with an outer surface of a wall of the hollow body. The reinforcement layer is formed from a fiber reinforced thermoplastic material comprising a plurality of fibers dispersed in a thermoplastic resin. The method further includes heating the reinforcement layer to a bonding temperature, and bonding the hollow body and the reinforcement layer.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a side view of vehicle according to one embodiment of the present disclosure;

FIG. 2 is perspective cut-away view of an airbag inflator according to one embodiment of the present disclosure;

FIG. 3 is a perspective view of one embodiment of a tape for use in the present disclosure;

FIG. 4 is a cross-sectional view of one embodiment of a tape for use in the present disclosure;

FIG. 5 is a cross-sectional view of one embodiment of a tape for use in the present disclosure; and

FIG. 6 is a cross-sectional view of an impregnation die utilized to form a reinforcement layer according to one embodiment of the present disclosure.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to airbag inflators. Airbag inflators according to the present disclosure are utilized in airbags to inflate the inflatable bags thereof. Such airbags are typically utilized in automobiles. An automobile according to the present disclosure may be a car, truck, sports utility vehicle, or other suitable wheeled passenger transport. However, use of airbags and airbag inflators according to the present disclosure is not limited to automobiles. Rather, use of such airbags and airbag inflators in any suitable vehicles, including automobiles, bicycles, motorcycles, trains, ships, boat, aircraft, spacecraft, etc., are within the scope and spirit of the present disclosure.

An airbag inflator according to the present disclosure includes a hollow body and a reinforcement layer surrounding the hollow body. The hollow body is typically formed from a metal. The reinforcement layer is formed from a fiber reinforced thermoplastic material. In exemplary embodiments, the thermoplastic resin utilized in the fiber reinforced thermoplastic material is polypropylene, polyphthalamide, or polyphenylene sulfide, and the fiber are continuous glass fibers. Further, in exemplary embodiments, the reinforcement layer is a tape formed from the fiber reinforced thermoplastic material and wrapped around the hollow body. Typically, the hollow body is surrounded with the reinforcement layer, and the reinforcement layer is then heated to a bonding temperature and bonded to the hollow body.

The use of a fiber reinforced thermoplastic material in an airbag inflator according to the present disclosure provides the airbag inflator with a variety of advantageous characteristics. For example, the reinforcement layer formed from the fiber reinforced thermoplastic material reinforces the airbag inflator, thus improving the strength characteristics, such as the hoop strength characteristics, and the pressure ratings of the airbag inflators. Further, due to the use of such reinforcement layers, the wall thickness of the hollow body can be decreased without the risk of losses in strength characteristics and pressure ratings. Thus, the overall weight of the airbag inflators can be reduced. Still further, the use of thermoplastic resins to form the reinforcement layer provides for relatively more efficiently and cost-effective production of the airbag inflators.

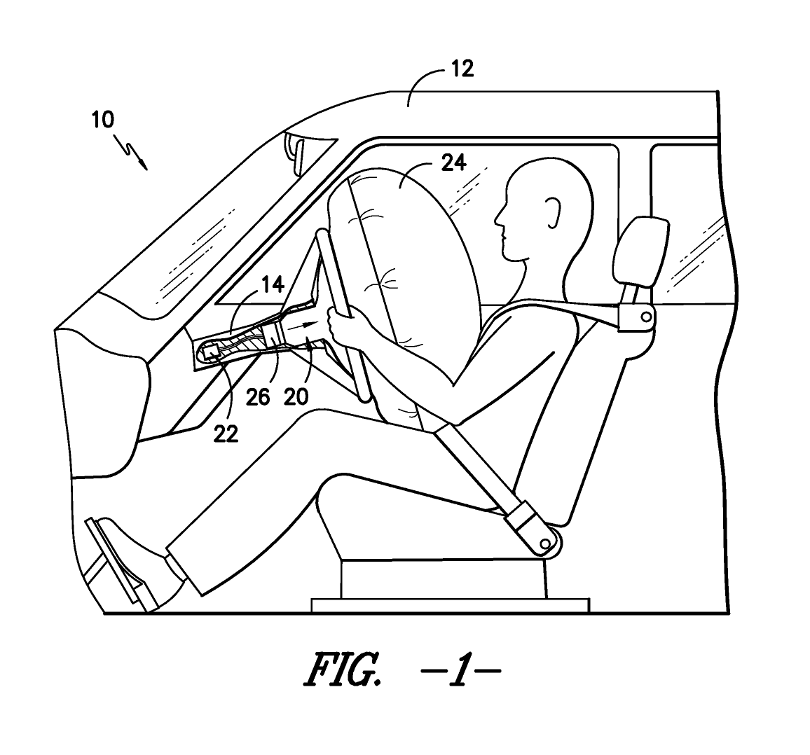

Referring now to FIG. 1, one embodiment of a vehicle 10 is shown. In this embodiment, the vehicle 10 is an automobile, although it should be understood as discussed above that any suitable vehicle is within the scope and spirit of the present disclosure. The vehicle includes a body 12 as shown, which may include a variety of components including, for example, frame and panel components. For example, the body 12 may include a steering column 14 as shown. The vehicle 10 may further include an airbag 20. The airbag 20 may be configured on the body 12. For example, the airbag 20 may be positioned in any suitable location in or on the body 12, or any suitable components thereof such as frame or panel components. The airbag 20 may further be designed to deploy into the interior of the vehicle or to the exterior of the vehicle, In some embodiments, as shown, the airbag may be provided in the steering column 14 such that, when deployed, a portion of the airbag 20 bursts through the steering column 14. However, it should be understood that the present disclosure is not limited to airbags 20 in steering columns 14 (which may be referred to as “front” or “driver's side” airbags in some contexts). Rather, any suitable airbag 20, including passenger airbags, side airbags, curtain airbags, knee airbags, carpet/floor airbags and pedestrian airbags, are within the scope and spirit of the present disclosure.

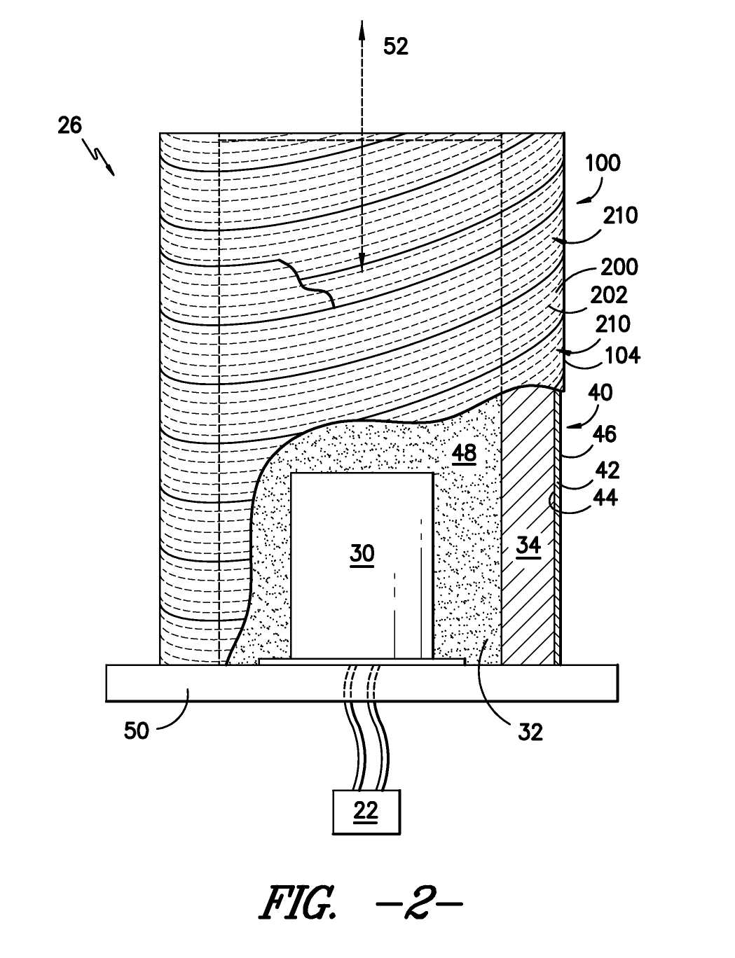

FIG. 2 illustrates one embodiment of an airbag according to the present disclosure. As shown, the airbag 20 includes a sensor 22, an inflatable bag 24, and an airbag inflator 26. The airbag inflator 26 is connected to the sensor 22 and the inflatable bag 24. For example, the airbag inflator 26 may be connected to the sensor 22 by wires or another suitable connection, and the airbag inflator 26 may be directly connected to the inflatable bag 24 such that operation of the airbag inflator 26 transfers a fluid (typically a gas) to the inflatable bag 24 to inflate and thus deploy the inflatable bag 24.

Any suitable airbag inflator 26 is within the scope and spirit of the present disclosure. For example, in the embodiment shown in FIG. 2, the airbag inflator is a pyrotechnic inflator. In this embodiment, the airbag inflator 26 thus includes an igniter 30 (which is typically connected to the sensor 22), and a propellant 32 which is ignited. The propellant 32 is typically sodium azide, which reacts with potassium nitrate to produce nitrogen gas, which inflates the inflatable bag 24. The airbag inflator 26 may further include a filter 34 surrounding the propellant. In other embodiments, however, the airbag inflator 26 may be a hybrid gas inflator, or any other suitable airbag inflation device or apparatus.

The airbag inflator 26 according to the present disclosure further includes a hollow body 40. The hollow body 40 generally surrounds the various interior components of the airbag inflator 26, such as in some embodiments the igniter 30, propellant 32, and filter 34. The hollow body 40 includes a wall 42, The wall 42 is in exemplary embodiments a generally cylindrical sidewall. In other embodiments, the wall 42 may be spherical, or have suitable cylindrical and/or spherical portions. In still further embodiments, the wall 42 may have any suitable shape. As shown, the wall 42 has an inner surface 44 and an outer surface 46. The inner surface 44 may define an interior 48 of the hollow body 40, in which the other various components of the airbag inflator 26 may be disposed. The hollow body 40 may further include other suitable portions, such as endcaps 50 as shown, or may consist solely of the wall 42.

In exemplary embodiments, the hollow body 40, such as the wall 42 thereof, is formed from a metal. The metal may be any suitable metal, metal alloy, or metal superalloy. For example, particularly suitable metals include steels and aluminums. Alternatively, however, the hollow body 40, such as the wall 42 thereof, may be formed from a suitable ceramic or composite, such as a thermoplastic as discussed herein.

As further shown in FIGS. 2 through 5, an airbag inflator 26 according to the present disclosure includes one or more reinforcement layer 100. Each reinforcement layer 100 generally surrounds the hollow body 40. For example, as shown, a reinforcement layer 100 surrounds and is bonded to the hollow body 40. Additional reinforcement layers 100 may surround and be bonded to this reinforcement layer 100 and to each other. A reinforcement layer 100 has an inner surface 102 and an outer surface 104. When the reinforcement layer 100 surrounds the hollow body 40, the inner surface 102 may contact the hollow body 40, such as the outer surface 46 of the wall 42 thereof. The reinforcement layer 100 and, optionally, the hollow body 40 may be heated, and may be pressed together or otherwise joined such that the reinforcement layer 100 and hollow body 40 are bonded together. Bonding of the reinforcement layer 100 with the hollow body 40 may advantageously reinforce the hollow body 100, as discussed herein.

A reinforcement layer 100 according to the present disclosure is formed from a fiber reinforced thermoplastic material. A fiber reinforced thermoplastic material includes a thermoplastic resin 200 and a plurality of fibers 202 disposed in the thermoplastic resin. A thermoplastic resin 200 according to the present disclosure is formed from any suitable thermoplastic material. Suitable thermoplastics for use in the present invention may include, for instance, polyolefins (e.g., polypropylene, propylene-ethylene copolymers, etc.), polyesters (e.g., polybutylene terephalate (“PBT”)), polycarbonates, polyamides (e.g., Nylon™), polyether ketones (e.g., polyetherether ketone (“PEEK”)), polyetherimides, polyarylene ketones (e.g., polyphenylene diketone (“PPDK”)), liquid crystal polymers, polyarylene sulfides (e.g., polyphenylene sulfide (“PPS”)), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes, polycarbonates, styrenic polymers (e.g., acrylonitrile butadiene styrene (“ABS”)), and so forth. Polypropylene, polyphthalamide, and polyphenylene sulfide are particularly suitable for applications according to the present disclosure.

The fibers 202 dispersed in the thermoplastic resin 200 to form a fiber reinforced thermoplastic material may be formed from any conventional material known in the art, such as metal fibers, glass fibers (e.g., E-glass, A-glass, C-glass, D-glass, AR-glass, R-glass, S1-glass, S2-glass), carbon fibers (e.g., graphite), boron fibers, ceramic fibers (e.g., alumina or silica), aramid fibers (e.g., Kevtar® marketed by E. I. duPont de Nemours, Wilmington, Del.), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing polymer compositions. Glass fibers are particularly desirable for use in applications according to the present disclosure.

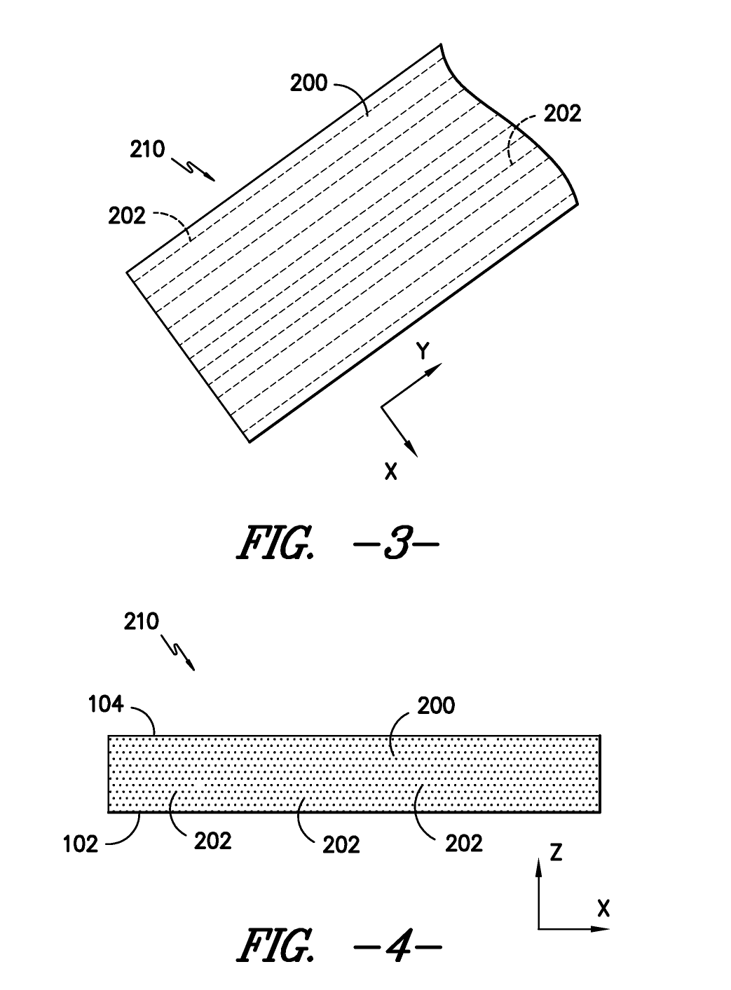

In exemplary embodiments, the fibers 202 utilized in the fiber reinforced thermoplastic material are continuous fibers, as shown in FIG. 3. Alternatively, however, the fibers may be long fibers. As used herein, the term “long fibers” generally refers to fibers, filaments, yarns, or rovings that are not continuous, and as opposed to “continuous fibers” which generally refer to fibers, filaments, yarns, or rovings having a length that is generally limited only by the length of a part.

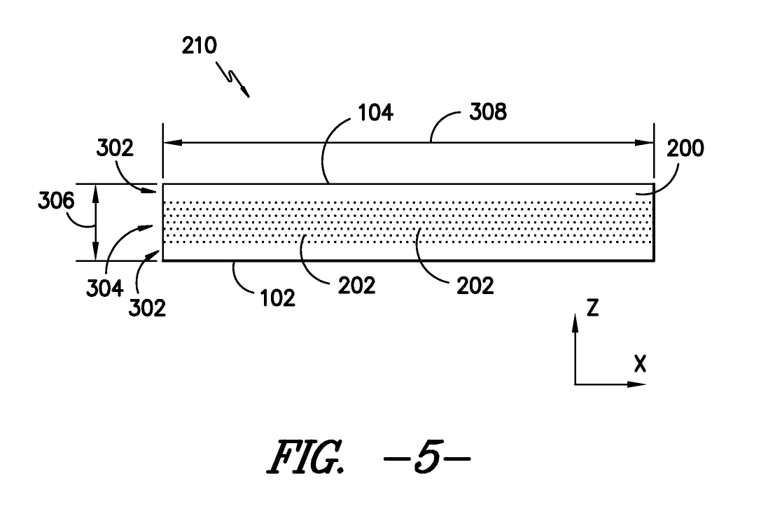

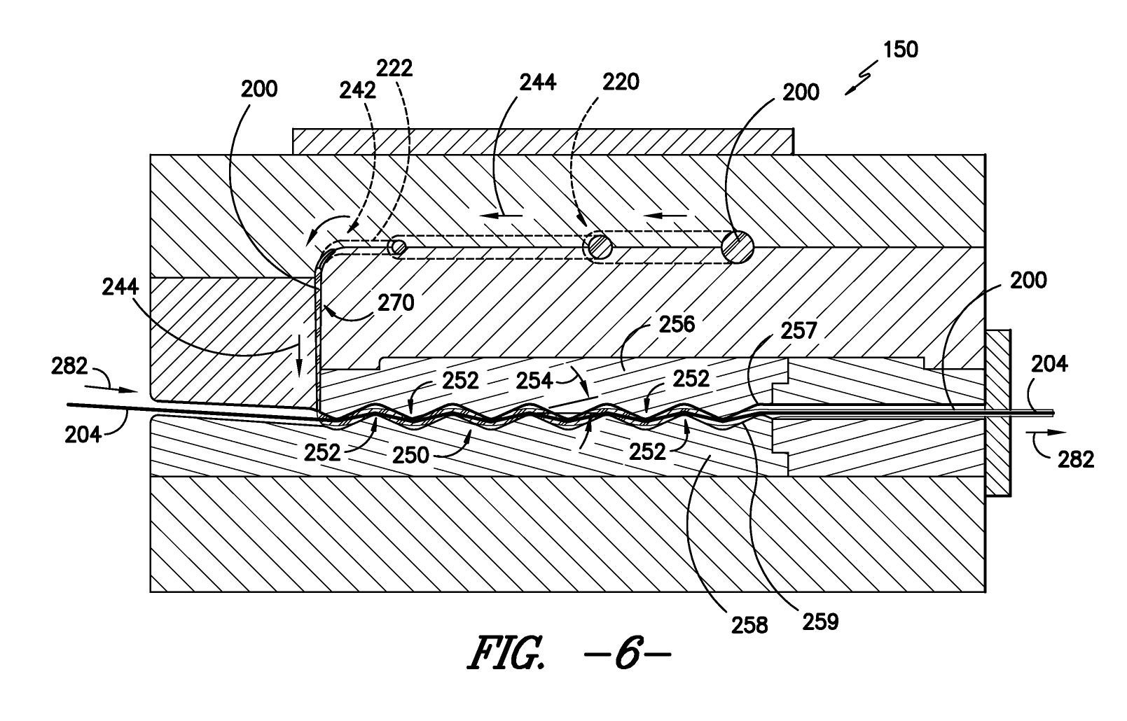

In some embodiment, the fibers 202 are generally dispersed throughout the entire reinforcement layer 100, such as throughout a cross-section thereof, as shown in FIG. 4. In other embodiments, a reinforcement layer 100 and material forming the layer 100, such as a cross-section thereof, may have one or more resin rich portions 302 and a fiber rich portion 304, as shown in FIG. 5. A first resin rich portion 302 may include the inner surface 102 of the reinforcement layer 100. Thus, when placed in contact with the hollow body 40, the first resin rich portion 302 may be proximate, and in contact with, the hollow body 40, such as the outer surface 48 thereof, and the fiber rich portion 304 may be spaced from the outer surface 48 of the hollow body 40 relative to the first resin rich portion 302. Such proximity of the first resin rich portion 302 may facilitate improved bonding of the reinforcement layer 100 with the hollow body 40. Because this portion 302 is resin rich, the resin may be relatively more efficiently heated to a temperature that allows consolidation and bonding with the hollow body 40. Better bonding thus results from the use of reinforcement layer 100 with a resin rich portion 302, which provides improved strength characteristics for the resulting airbag inflator 26.

In some embodiments, the fiber rich portion 304 may include the outer surface 104. In these embodiments, the reinforcement layer 100 may include only one resin rich portion 302, and may thus be asymmetric. In other embodiments, as shown in FIG. 5, the reinforcement layer 100 may further include a second resin rich portion 302. The second resin rich portion 302 may include the outer surface 104, and the fiber rich portion 304 may be disposed between the first resin rich portion 302 and the second resin rich portion 302. The second resin rich portion 302 may facilitate improved bonding of the reinforcement layer 100 with, for example, a second reinforcement layer 100 or any other suitable layer that is brought into contact with the reinforcement layer 100. Because this portion 302 is resin rich, the resin may be relatively more efficiently heated to a temperature that allows consolidation and bonding with this outer layer. Better bonding thus results from the use of reinforcement layer 100 with two opposing resin rich portions 302, which provides improved strength characteristics for the resulting airbag inflator 26.

In exemplary embodiments as shown, a reinforcement layer 100 is a tape 210 formed from the fiber reinforced thermoplastic material. The tape may be wrapped around hollow body 40 to surround the hollow body 40. For example, in some exemplary embodiments as shown in FIG. 2, the tape may be wrapped around the hollow body 40 generally helically with respect to a longitudinal axis 52 of the hollow body 40. Various embodiments of such tapes 210 are shown in FIGS. 2 through 5 and discussed below.

A tape according to the present disclosure may be formed using any suitable process or apparatus. Further, any suitable process and apparatus may be utilized to form the fiber reinforced thermoplastic material. For example, in some embodiments, the thermoplastic resin may initially be extruded through a suitable extrusion device, and may then be provided into an impregnation die. Fibers, such as rovings thereof, may be provided in the impregnation die and embedded in the thermoplastic resin. As used herein, the term “roving” generally refers to a bundle of individual fibers. The fibers contained within the roving can be twisted or can be straight. The rovings may contain a single fiber type or different types of fibers. Different fibers may also be contained in individual rovings or, alternatively, each roving may contain a different fiber type. The fibers employed in the rovings may possess a high degree of tensile strength relative to their mass. For example, the ultimate tensile strength of the fibers is typically from about 1,000 to about 15,000 Megapascals (“MPa”), in some embodiments from about 2,000 MPa to about 10,000 MPa, and in some embodiments, from about 3,000 MPa to about 6,000 MPa. Such tensile strengths may be achieved even though the fibers are of a relatively light weight, such as a mass per unit length of from about 0.05 to about 3 grams per meter, in some embodiments from about 0.4 to about 1.5 grams per meter, The ratio of tensile strength to mass per unit length may thus be about 1,000 Megapascals per gram per meter (“MPa/g/m”) or greater, in some embodiments about 4,000 MPa/g/m or greater, and in some embodiments, from about 5,500 to about 20,000 MPa/g/m. The number of fibers contained in each roving can be constant or vary from roving to roving. Typically, a roving contains from about 1,000 fibers to about 50,000 individual fibers, and in some embodiments, from about 5,000 to about 30,000 fibers.

One embodiment of an impregnation die 150 is shown in FIG. 6. As shown, resin 200 is flowed into the die 150 as indicated by resin flow direction 244. The resin 200 is distributed within the die 150 and then interacted with the rovings 204. The rovings 204 are traversed through the die 150 in roving run direction 282, and are coated with resin 200. The rovings 204 are then impregnated with the resin 200, and these impregnated rovings 204 exit the die 150. In some embodiments the impregnated rovings 202 are connected by the resin 200 and thus exist as tape 210. In other embodiments the impregnated ravings 204 exit the die separately, each impregnated within resin 200, and are then consolidated to form tape 210.

Within the impregnation die, it is generally desired that the rovings 204 are traversed through an impregnation zone 250 to impregnate the rovings 204 with the thermoplastic resin 200. In the impregnation zone 250, the thermoplastic resin 200 may be forced generally transversely through the rovings by shear and pressure created in the impregnation zone 250, which significantly enhances the degree of impregnation. This is particularly useful when forming a composite from tapes of a high fiber content, such as about 35% weight fraction (“Wf”) or more, and in some embodiments, from about 40% Wf or more. Typically, the die 150 will include a plurality of contact surfaces 252, such as for example at least 2, at least 3, from 4 to 7, from 2 to 20, from 2 to 30, from 2 to 40, from 2 to 50, or more contact surfaces 252, to create a sufficient degree of penetration and pressure on the ravings 204, Although their particular form may vary, the contact surfaces 252 typically possess a curvilinear surface, such as a curved lobe, pin, etc. The contact surfaces 252 are also typically made of a metal material.

As shown, the impregnation die 150 includes a manifold assembly 220 and an impregnation section. The impregnation section includes an impregnation zone 250. In some embodiments, the impregnation section additionally includes a gate passage 270. The manifold assembly 220 is provided for flowing the thermoplastic resin 200 therethrough. For example, the manifold assembly 220 may include a channel 222 or a plurality of channels 222. The resin 214 provided to the impregnation die 150 may flow through the channels 222. The plurality of channels 222 may, in exemplary embodiments, be a plurality of branched runners 222. For example, one, two, three or more groups of branched runners 222 may feed into and from one another. Further, in some exemplary embodiments, the plurality of branched runners 222 have a symmetrical orientation along a central axis. The branched runners 222 and the symmetrical orientation thereof may generally evenly distribute the resin 200, such that the flow of resin 200 exiting the manifold assembly 220 and coating the rovings 204 is substantially uniformly distributed on the ravings 204. This desirably allows for generally uniform impregnation of the ravings 204.

As further shown, after flowing through the manifold assembly 220, the resin 200 may flow through gate passage 270. Gate passage 270 is positioned between the manifold assembly 220 and the impregnation zone 250, and is provided for flowing the resin 200 from the manifold assembly 220 such that the resin 214 coats the rovings 204. Gate passage 270 may be generally vertical (as shown with reference to FIG. 6) or at any suitable angle to vertical. Thus, resin 200 exiting the manifold assembly 220, such as through outlet region 242, may enter gate passage 270 and flow therethrough.

Upon exiting the manifold assembly 220 and the gate passage 270 of the die 150 as shown, the resin 200 contacts the ravings 204 being traversed through the die 150. As discussed above, the resin 200 may substantially uniformly coat the rovings 204, due to distribution of the resin 200 in the manifold assembly 220 and the gate passage 270. Further, in some embodiments, the resin 200 may impinge on an upper surface of each of the rovings 204, or on a lower surface of each of the ravings 204, or on both an upper and lower surface of each of the rovings 204. Initial impingement on the rovings 204 provides far further impregnation of the rovings 204 with the resin 200. Impingement on the rovings 204 may be facilitated by the velocity of the resin 200 when it impacts the rovings 204, the proximity of the rovings 204 to the resin 200 when the resin exits the manifold assembly 220 or gate passage 270, or other various variables.

As shown, the coated rovings 204 are traversed in run direction 282 through impregnation zone 250. The impregnation zone 250 is in fluid communication with the manifold assembly 220, such as through the gate passage 270 disposed therebetween. The impregnation zone 250 is configured to impregnate the ravings 204 with the resin 200.

For example, as discussed above, in exemplary embodiments, the impregnation zone 250 includes a plurality of contact surfaces 252. The rovings 204 are traversed over the contact surfaces 252 in the impregnation zone. Impingement of the ravings 204 on the contact surface 252 creates shear and pressure sufficient to impregnate the ravings 204 with the resin 200 coating the rovings 204.

In some embodiments, as shown, the impregnation zone 250 is defined between two spaced apart opposing impregnation plates 256 and 258, which may be included in the impregnation section. First plate 256 defines a first inner surface 257, while second plate 258 defines a second inner surface 259. The impregnation zone 250 is defined between the first plate 256 and the second plate 258. The contact surfaces 252 may be defined on or extend from both the first and second inner surfaces 257 and 259, or only one of the first and second inner surfaces 257 and 259.

In exemplary embodiments, as shown, the contact surfaces 252 may be defined alternately on the first and second surfaces 257 and 259 such that the rovings alternately impinge on contact surfaces 252 on the first and second surfaces 257 and 259. Thus, the ravings 204 may pass contact surfaces 252 in a waveform, tortuous or sinusoidual-type pathway, which enhances shear.

Angle 254 at which the rovings 204 traverse the contact surfaces 252 may be generally high enough to enhance shear and pressure, but not so high to cause excessive forces that will break the fibers. Thus, for example, the angle 254 may be in the range between approximately 1° and approximately 30°, and in some embodiments, between approximately 5° and approximately 25°.

As stated above, contact surfaces 252 typically possess a curvilinear surface, such as a curved lobe, pin, etc. In exemplary embodiments as shown, a plurality of peaks, which may form contact surfaces 252, and valleys are thus defined. Further, in many exemplary embodiments, the impregnation zone 250 has a waveform cross-sectional profile. In one exemplary embodiment as shown, the contact surfaces 252 are lobes that form portions of the waveform surfaces of both the first and second plates 256 and 258 and define the waveform cross-sectional profile. In other embodiments, the contact surfaces 252 are lobes that form portions of a waveform surface of only one of the first or second plate 256 or 258. In these embodiments, impingement occurs only on the contact surfaces 252 on the surface of the one plate. The other plate may generally be flat or otherwise shaped such that no interaction with the coated rovings occurs.

In other alternative embodiments, the impregnation zone 250 may include a plurality of pins (or rods), each pin having a contact surface 252. The pins may be static, freely rotational (not shown), or rotationally driven. Further, the pins may be mounted directly to the surface of the plates defining the impingement zone, or may be spaced from the surface. It should be noted that the pins may be heated by heaters, or may be heated individually or otherwise as desired or required. Further, the pins may be contained within the die 150, or may extend outwardly from the die 150 and not be fully encased therein.

In further alternative embodiments, the contact surfaces 252 and impregnation zone 250 may comprise any suitable shapes and/or structures for impregnating the ravings 204 with the resin 200 as desired or required.

As discussed, a roving 204 traversed through an impregnation zone 250 according to the present disclosure may become impregnated by resin 200, thus resulting in an impregnated roving 204, and optionally a tape 210 comprising at least one roving 204, exiting the impregnation zone 250, such as downstream of the contact surfaces 252 in the run direction 282. The impregnated rovings 204 and tape 210 exiting the impregnation zone 250 are thus formed from a fiber reinforced thermoplastic material, as discussed above. At least one fiber roving 204 may be dispersed within a thermoplastic resin 200, as discussed above, to form the fiber reinforced thermoplastic material and resulting tape 210. Further, in exemplary embodiments of the present disclosure, such tape 210 may include a at least one resin rich portion 302 and a fiber rich portion 304.

FIG. 5 illustrates embodiments of a tape 210 having opposing resin rich portions 302 according to the present disclosure. As discussed, such tape 210 may include a first resin rich portion 302, a second resin rich portion 302, and a fiber rich portion 304 disposed between the resin rich portions 302. In some embodiments, the tape 210 consists solely of the resin rich portions 302 and fiber rich portion 304. These portions may in some embodiments be defined as respective thirds of a tape 210, such as when viewed as a cross-section. For example, each resin rich portion 302 may include that portion of the tape 210 within one-third of the height 306 throughout all of the width 308.

In other embodiments, the resin rich portions 302 and fiber rich portion 304 may be viewed as more or less than a third of a tape 210 as discussed above. For example, a resin rich portion 302 may be less than third of the tape 210, such as less than or equal to approximately 5%, 10%, 20%, or 30% of the height 306 throughout the width 308. A fiber rich portion 302 may be greater than or equal to approximately 95%, 90%, 80%, 70%, 60%, 50%, or 40% of the height 306 throughout the width 308.

A resin rich portion 302 according to the present disclosure may include relatively more resin 200 than fibers 202, while a fiber rich portion 304 may include relatively more fibers 202 than resin 200. In some embodiments, such ratio may be calculated on a per volume basis for a tape 210, or on a per surface area basis for a cross-section of a tape 210. In these embodiments, such ratio may further be calculated as an average throughout all or a portion of a tape 210, such as throughout all or a portion of the length of a tape 210 using the volume thereof or using a plurality of cross-sections.

For example, a resin rich portion 302 in some embodiments may include at least approximately 60%, 65%, 70%, 75%, 80%, 85%, or any other suitable percentage, range, or sub-range thereof of the total amount of resin 200. The total amount may include the amount in both the resin rich portions 302 and the fiber rich portion 304. In other embodiments, the ratio of resin 200 to fibers 202 in the resin rich portion 302 may be at least approximately 1.2 to 1, 1.6 to 1, 2 to 1, 2.4 to 1, 2.8 to 1, 3.2 to 1, 3.6 to 1, 4.0 to 1, or any other suitable ratio, range, or sub-range thereof. As discussed above, the total amount or ratio may be calculated on a per volume basis or a per surface area basis for a cross-sectional area of a tape 210.

Further, the fiber rich portion 304 in some embodiments may include at least approximately 60%, 65%, 70%, 75%, 80%, 85%, or any other suitable percentage, range, or sub-range thereof of the total amount of fiber 202. The total amount may include the amount in both the resin rich portions 302 and the fiber rich portion 304. In other embodiments, the ratio of fiber 202 to resin 200 in the fiber rich portion 304 may be at least approximately 1.2 to 1, 1.6 to 1, 2 to 1, 2.4 to 1, 2.8 to 1, 3.2 to 1, 3.6 to 1, 4.0 to 1, or any other suitable ratio, range, or sub-range thereof. As discussed above, the total amount or ratio may be calculated on a per volume basis or a per surface area basis for a cross-sectional area of a tape 210.

Additionally or alternatively, a resin rich portion 302 in some embodiments may include a percentage resin 200 (as opposed to fibers 202 contained in the resin rich portion 302) of at least approximately 75%, 80%,85%, 90%, 95%, 100% or any other suitable percentage, range, or sub-range thereof. Such percentage may be calculated on a per volume basis or a per surface area basis for a cross-sectional area of a tape 210.

The tapes 210 that result from use of the die 150 and method according to the present disclosure may have a very low void fraction, which helps enhance their strength. For instance, the void fraction may be about 3% or less, in some embodiments about 2% or less, in some embodiments about 1.5% or less, in some embodiments about 1% or less, and in some embodiments, about 0.5% or less. The void fraction may be measured using techniques well known to those skilled in the art. For example, the void fraction may be measured using a “resin burn off” test in which samples are placed in an oven (e.g., at 600° C. for 3 hours) to burn out the resin. The mass of the remaining fibers may then be measured to calculate the weight and volume fractions. Such “burn off” testing may be performed in accordance with ASTM D 2584-08 to determine the weights of the fibers and the polymer matrix, which may then be used to calculate the “void fraction” based on the following equations:

V_{f}=100*(ρₜ−ρ_{c})/ρₜ

where,

V_{f} is the void fraction as a percentage;

ρ_{c} is the density of the composite as measured using known techniques, such as with a Liquid or gas pycnometer (e.g., helium pycnometer);

ρₜ is the theoretical density of the composite as is determined by the following equation:

ρₜ=1/[W_{f}/ρ_{f}+Wₘ/ρₘ]

ρₘ is the density of the polymer matrix (e.g., at the appropriate crystallinity);

ρ_{f} is the density of the fibers;

W_{f} is the weight fraction of the fibers; and

Wₘ is the weight fraction of the polymer matrix.

Alternatively, the void fraction may be determined by chemically dissolving the resin in accordance with ASTM D 3171-09. The “burn off” and “dissolution” methods are particularly suitable for glass fibers, which are generally resistant to melting and chemical dissolution. In other cases, however, the void fraction may be indirectly calculated based on the densities of the polymer, fibers, and tape in accordance with ASTM D 2734-09 (Method A), where the densities may be determined ASTM D792-08 Method A. Of course, the void fraction can also be estimated using conventional microscopy equipment.

As discussed above, after exiting the impregnation die 150, the impregnated rovings 204 may in some embodiments form a tape 210. Additionally or alternatively, the impregnated rovings 204 and/or tape 210 may be consolidated into a consolidated tape 210. The number of rovings employed in each tape 210 may vary. Typically, however, a tape 210 will contain from 2 to 80 rovings, and in some embodiments from 10 to 60 rovings, and in some embodiments, from 20 to 50 rovings. In some embodiments, it may be desired that the rovings are spaced apart approximately the same distance from each other within the tape 210. In other embodiments, as shown in however, it may be desired that the ravings are combined, such that the fibers of the ravings are generally evenly distributed throughout the tape 210, such as throughout one or more resin rich portions and a fiber rich portion as discussed above. In these embodiments, the ravings may be generally indistinguishable from each other. Referring to FIGS. 3 through 5, for example, embodiments of a tape 210 are shown that contains rovings that are combined such that the fibers 202 are generally evenly distributed within the resin 200, and in the case of FIG. 5 within a fiber rich portion thereof.

A relatively high percentage of fibers may be employed in a tape, and fiber reinforced thermoplastic material thereof, to provide enhanced strength properties. For instance, fibers typically constitute from about 25 wt. % to about 90 wt. %, in some embodiments from about 30 wt. % to about 75 wt. %, and in some embodiments, from about 35 wt. % to about 70 wt. % of the tape or material thereof. Likewise, polymer(s) typically constitute from about 20 wt. % to about 75 wt. %, in some embodiments from about 25 wt. % to about 70 wt. %, and in some embodiments, from about 30 wt. % to about 65 wt. % of the tape 152, 156. Such percentage of fibers may additionally or alternatively by measured as a volume fraction. For example, in some embodiments, the fiber reinforced thermoplastic material may have a fiber volume fraction between approximately 25% and approximately 80%, in some embodiments between approximately 30% and approximately 70%, in some embodiments between approximately 40% and approximately 60%, and in some embodiments between approximately 45% and approximately 55%.

After leaving the impregnation die 150, impregnated rovings 204 and tape 210, which may comprises the fiber reinforced thermoplastic material, may enter an optional pre-shaping or guiding section (not shown) and/or a preheating device to control the temperature thereof before entering a nip formed between two adjacent rollers. Although optional, the rollers can help to consolidate the impregnated rovings 204 into a tape 210 or consolidate the tape 210 into a final tape 210, as well as enhance fiber impregnation and squeeze out any excess voids. In addition to the rollers, other shaping devices may also be employed, such as a die system. Regardless, the resulting consolidated tape 210 is pulled by tracks and mounted on rollers. The tracks also pull the impregnated rovings 204 or tape 210 from the impregnation die 150 and through the rollers. If desired, the consolidated tape 210 may then be wound up. Generally speaking, the resulting tapes are relatively thin and typically have a thickness of from about 0.05 to about 1 millimeter, in some embodiments from about 0.1 to about 0.8 millimeters, and in some embodiments, from about 0.1 to about 0.4 millimeters.

It should be understood that tapes 210 according to the present disclosure need not be formed in the dies 150 and other apparatus as discussed above. Such dies 150 and apparatus are merely disclosed as examples of suitable equipment for forming tapes 210. The use of any suitable equipment or process to form tapes 210 is within the scope and spirit of the present disclosure. It should further be understood that reinforcement layers 100 according to the present disclosure are not limited to tapes 210. Rather, any suitable reinforcement layers, such as continuous wraps, sleeves, or other suitable layers formed from the fiber reinforced thermoplastic material, are within the scope and spirit of the present disclosure.

The present disclosure is further directed to methods for forming airbag inflator 26. A method according to the present disclosure may include, for example, surrounding a hollow body 40 with one or more reinforcement layers 100. With respect to the reinforcement layer 100 immediately adjacent to the hollow body 40, the reinforcement layer 100 may surround the hollow body 40 such that an inner surface 102 of the reinforcement layer 100 is in contact with an outer surface 46 of a wall 42 of the hollow body 40. The reinforcement layer 100 is formed from a fiber reinforced thermoplastic material comprising a plurality of fibers 202 dispersed in a thermoplastic resin 200.

In some embodiments, the surrounding step includes wrapping the reinforcement layer 100 around the hollow body 40, such as generally helically with respect to a longitudinal axis 52 of the hollow body 40. Further, in some embodiments, the reinforcement layer 100 is a tape 210 formed from the fiber reinforced thermoplastic material, as discussed above.

The method may further include heating the reinforcement layer 100 and, optionally, the hollow body 40, to bonding temperatures. Heating may be performed in a die 150 or otherwise during formation of the reinforcement layer 100 or tape 210 thereof, or may be separately performed. A suitable heating source may be, for example, infrared, hot gas, laser, or otherwise. A consolidation temperature is a temperature that allows the reinforcement layer 100 and hollow body 40 to be bonded together. For example, the bonding temperature for a particular thermoplastic resin may be the melting point temperature, or a temperature between approximately 20° C., 15° C., 10° C., or 5° C. below the melting point temperature and the melting point temperature for that polymer resin. The method may further include consolidating the hollow body 40 and the reinforcement layer 100. Bonding may involve, for example, pressing the hollow body 40 and reinforcement layer 100 together, or simply allowing the hollow body 40 and reinforcement layer 100 to remain in contact, after heating thereof. The method may further include cooling the resulting airbag inflator 26 after bonding of the hollow body 40 and reinforcement layer 100.

In some embodiments, and in particular when the reinforcement layer 100 includes opposing resin rich portions 302, the method may further include surrounding the reinforcement layer with a second reinforcement layer 100, and heating and bonding these layers as disclosed herein with respect to the reinforcement layer 100 and hollow body 40.

In some embodiments, the method may further include forming the reinforcement layer 100, such as the tape 210 that forms the reinforcement layer 100. Such forming may include, for example, flowing a polymer resin 200 through a manifold assembly 220. The manifold assembly 220 may include a plurality of channels or branched runners 222, as discussed above. The forming step may further include coating one or more fiber rovings 204 with the resin 200, as discussed above. Further, the forming step may include traversing the coated roving 204 through an impregnation zone 250 to impregnate the rovings 204 with the resin 200, as discussed above. Such traversing step may include contacting a plurality of contact surfaces 252 as discussed above.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. An airbag inflator, comprising:
a hollow body comprising a wall, the wall having an inner surface defining an interior and an outer surface;
a reinforcement layer surrounding and bonded to the hollow body, the reinforcement layer having an inner surface and an outer surface, the inner surface of the reinforcement layer in contact with the outer surface of the wall, the reinforcement layer formed from a fiber reinforced thermoplastic material comprising a plurality of fibers dispersed in a thermoplastic resin.

2. The airbag inflator of claim 1, wherein the reinforcement layer is a tape formed from the fiber reinforced thermoplastic material.

3. The airbag inflator of claim 2, wherein the tape is wrapped generally helically around the hollow body with respect to a longitudinal axis of the hollow body.

4. The airbag inflator of claim 1, wherein the plurality of fibers are a plurality of continuous fibers.

5. The airbag inflator of claim 1, wherein the plurality of fibers are a plurality of glass fibers.

6. The airbag inflator of claim 1, wherein the thermoplastic resin is one of polypropylene, polyphthalamide, or polyphenylene sulfide.

7. The airbag inflator of claim 1, wherein the wall is formed from a metal.

8. The airbag inflator of claim 1, wherein the reinforcement layer comprises a resin rich portion and a fiber rich portion, the resin rich portion comprising the inner surface of the reinforcement layer, the fiber rich portion spaced from the inner surface of the reinforcement layer.

9. An automobile, comprising:
an automobile body; and
an airbag configured on the automobile body, the airbag comprising:
an inflatable bag;
a sensor; and
an airbag inflator connected to the inflatable bag and the sensor, the airbag inflator comprising:
a hollow body comprising a wall, the wall having an inner surface defining an interior and an outer surface;
a reinforcement layer surrounding and bonded to the hollow body, the reinforcement layer having an inner surface and an outer surface, the inner surface of the reinforcement layer in contact with the outer surface of the wall, the reinforcement layer formed from a fiber reinforced thermoplastic material comprising a plurality of fibers dispersed in a thermoplastic resin.

10. The automobile of claim 9, wherein the reinforcement layer is a tape formed from the fiber reinforced thermoplastic material.

11. The automobile of claim 10, wherein the tape is wrapped generally helically around the hollow body with respect to a longitudinal axis of the hollow body.

12. The automobile of claim 9, wherein the plurality of fibers are a plurality of continuous fibers.

13. The automobile of claim 9, wherein the plurality of fibers are a plurality of glass fibers.

14. The automobile of claim 9, wherein the thermoplastic resin is one of polypropylene, polyphthalamide, or polyphenylene sulfide.

15. The automobile of claim 9, wherein the wall is formed from a metal.

16. The automobile of claim 9, wherein the reinforcement layer comprises a resin rich portion and a fiber rich portion, the resin rich portion comprising the inner surface of the reinforcement layer, the fiber rich portion spaced from the inner surface of the reinforcement layer.

17. A method for forming an airbag inflator, the method comprising:
surrounding a hollow body with a reinforcement layer such that an inner surface of the reinforcement layer is in contact with an outer surface of a wall of the hollow body, the reinforcement layer formed from a fiber reinforced thermoplastic material comprising a plurality of fibers dispersed in a thermoplastic resin;
heating the reinforcement layer to a bonding temperature; and
bonding the hollow body and the reinforcement layer.

18. The method of claim 17, wherein the surrounding step comprises wrapping the reinforcement layer generally helically around the hollow body with respect to a longitudinal axis of the hollow body.

19. The method of claim 17, wherein the reinforcement layer is a tape formed from the fiber reinforced thermoplastic material.

20. The method of claim 19, further comprising forming the tape, the forming step comprising:
flowing a thermoplastic resin through a manifold assembly of a die, the manifold assembly comprising a plurality of branched runners;
coating at least one fiber roving with the resin; and
traversing the coated roving through an impregnation zone of the die to impregnate the roving with the resin.
